(19) United States
(12) Patent Application Publication
(10) Pub. No.: US 2023/0314743 A1
(43) Pub. Date: Oct. 5, 2023

(54) OPTICAL FIBER CABLE

(71) Applicant: NIPPON TELEGRAPH AND TELEPHONE CORPORATION, Tokyo (JP)

(72) Inventors: Yuta MARUO, Musashino-shi, Tokyo (JP); Hiroaki TANIOKA, Musashino-shi, Tokyo (JP); Shigekatsu TETSUTANI, Musashino-shi, Tokyo (JP); Yusuke YAMADA, Musashino-shi, Tokyo (JP); Akira SAKURAI, Musashino-shi, Tokyo (JP)

(73) Assignee: NIPPON TELEGRAPH AND TELEPHONE CORPORATION, Tokyo (JP)

(21) Appl. No.: 18/009,774

(22) PCT Filed: Jun. 16, 2020
(86) PCT No.: PCT/JP2020/023564

§ 371 Date: Dec. 12, 2022

(51) Int. Cl. G02B 6/44

(52) U.S. Cl. CPC G02B 6/443

(57) ABSTRACT

The object of the present disclosure is to provide an optical fiber cable having a large contact area with the bottom surface of a rectangular groove and easily bent in at least two directions, as compared to an optical fiber cable having a circular cross-sectional shape perpendicular to a long axis direction. Therefore, the optical fiber cable of the present disclosure has three or more flat side surfaces in the long axis direction and two or more axes each having a minimum moment of inertia of area with respect to neutral planes.

### TECHNICAL FIELD

The present disclosure relates to an optical fiber cable.

### BACKGROUND ART

An optical fiber cable is used as a transmission medium for information communication. In a data communication service using an optical fiber by fiber to the home (FTTH), a drop optical cable is terminated at a subscriber house or the like by using an aerial wiring technology or an underground wiring technology.

Traditionally, when a new drop optical cable is to be installed in a subscriber house or the like, in most cases, an additional drop optical cable is installed in an area where a metallic cable for communication is already connected to the nearest utility pole. In these cases, since the infrastructure equipment such as utility poles and ducts is already installed, it is possible to lay an optical fiber cable economically without any new engineering work. This is because the place where there is a communication demand is the same as the place where the prior metallic cable has been wired, so additional installation is possible without constructing new infrastructure equipment.

A drop optical cable needs to be installed at a subscriber house or building through pipes. A pair of tension members are provided inside an outer cover of the drop optical cable to provide rigidity so that the drop optical cable can withstand tension applied when the drop optical cable is laid inside a pipe (for example, see PTL 1).

In recent years, in order to widely deploy antennas for mobile phones, there has been a need to lay optical fiber cables even in areas where no infrastructure equipment has been installed so far. Furthermore, although infrastructure equipment has already been installed, there is a need to newly perform wiring in structures such as street lights on the road, instead of wiring in houses or buildings. In these cases, a technology for economically wiring optical fiber cables without any engineering work as much as possible has been proposed (for example, see NPL 1). In an example of this method, an optical fiber cable is laid in a groove dug on the road surface.
PTL 1: JP 2013-041092 A
PTL 2: JP 2001-147353 A

### CITATION LIST

### Patent Literature

### Non Patent Literature

NPL 1: Strain Sensing of an In-Road FTTH Field Trial and Implications for Network Reliability, Proc. of IWCS (2019)

### SUMMARY OF THE INVENTION

### Technical Problem

However, a drop optical cable provided with a pair of tension members is limited to be bent with a small force only in a direction perpendicular to one neutral plane passing through the centers of both of the pair of tension members. Therefore, when there is a need for bending in a plurality of directions such as bending in a horizontal direction with respect to the ground on the curve at the time of road surface wiring and bending in a direction perpendicular to the ground when pulling up a cable to structures such as street lights on the road, such a drop optical cable is not suitable for the need. In order to bend a drop optical cable in a plurality of directions, it is necessary to lay the drop optical cable by twisting it by 90° in at least one direction.

Since a circular cross-sectional optical fiber cord (for example, see PTL 2) used indoors is not provided with a tension member as in a drop optical cable, it is easily bent in any direction. However, when a rectangular groove is dug in the road surface for wiring, an optical fiber cord can be caused to move in the groove and protrude from the groove. Protruding of the optical fiber cord from the groove may hinder traffic on the road. As described above, the optical fiber cord disclosed in PTL 2 has a problem in that it is easy to be caused to move in the groove because a contact area with the groove is small.

The present disclosure has been made to solve the above problems, and an object of the present disclosure is to provide an optical fiber cable having a large contact area with the bottom surface of a rectangular groove and easily bent in at least two directions, as compared to an optical fiber cable having a circular cross-sectional shape perpendicular to a long axis direction.

### Means for Solving the Problem

To achieve the above object, an optical fiber cable of the present disclosure has three or more flat side surfaces in a long axis direction and two or more neutral planes.

Specifically, the optical fiber cable of the present disclosure includes three or more flat side surfaces in a long axis direction, and two or more axes each having a minimum moment of inertia of area with respect to neutral planes.

Specifically, in addition to the above features, the optical fiber cable of the present disclosure includes four or more flat side surfaces in the long axis direction, there are two or more sets of parallel side surfaces, facing each other, of the four or more flat side surfaces, one set of parallel side surfaces and another set of parallel side surfaces of the two or more sets of parallel side surfaces are positioned at right angles to each other, edges of side surfaces positioned at right angles to each other of the two or more sets of parallel side surfaces are not in contact with each other, and a side surface connecting the side surfaces positioned at right angles to each other is inside extension surfaces of the side surfaces positioned at right angles to each other.

### Effects of the Invention

The optical fiber cable of the present disclosure has a large contact area with the bottom surface of a rectangular groove and is easily bent in at least two directions, as compared to an optical fiber cable having a circular cross-sectional shape perpendicular to a long axis direction.

### BRIEF DESCRIPTION OF DRAWINGS

FIG. 1 is a diagram illustrating an example of the structure of an optical fiber cable according to the present disclosure.

FIG. 2A is a diagram illustrating an example of the structure of an optical fiber cable according to the present disclosure.

FIG. 2B is a diagram illustrating an example of the structure of an optical fiber cable according to the present disclosure.

FIG. 3 is a diagram illustrating an example of the structure of an optical fiber cable according to the present disclosure.

FIG. 4 is a diagram illustrating an example of laying an optical fiber cable according to the present disclosure.

FIG. 5 is a diagram illustrating an example of the structure of an optical fiber cable according to the present disclosure.

FIG. 6 is a diagram illustrating an example of the structure of an optical fiber cable according to the present disclosure.

FIG. 7 is a diagram illustrating an example of the structure of an optical fiber cable according to the present disclosure.

FIG. 8 is a diagram illustrating an example of laying an optical fiber cable according to the present disclosure.

FIG. 9 is a diagram illustrating an example of the structure of an optical fiber cable according to the present disclosure.

FIG. 10 is a diagram illustrating an example of the structure of an optical fiber cable according to the present disclosure.

FIG. 11 is a diagram illustrating an example of the structure of an optical fiber cable according to the present disclosure.

FIG. 12 is a diagram illustrating an example of the structure of an optical fiber cable according to the present disclosure.

FIG. 13 is a diagram illustrating an example of laying an optical fiber cable according to the present disclosure.

### DESCRIPTION OF EMBODIMENTS

Hereinafter, embodiments of the present disclosure will be described in detail with reference to the drawings. Further, the present disclosure is not limited to the embodiments described below. These examples of the embodiments are merely examples, and the present disclosure can be implemented in forms in which various modifications and improvements are added based on knowledge of those skilled in the art. Constituent elements with the same reference signs in the specification and the drawings are assumed to be the same constituent elements.

### First Embodiment

An optical fiber cable of the present embodiment has a structure having three or more flat side surfaces in a long axis direction and two or more axes each having a minimum moment of inertia of area with respect to neutral planes. The smaller the moment of inertia of area is, the easier it is to bend, and having the two or more axes enables the optical fiber cable to be bent in two or more directions with a minimum force. Examples of the optical fiber cable includes an optical fiber cable having an equilateral triangular cross-sectional shape perpendicular to the long axis direction.

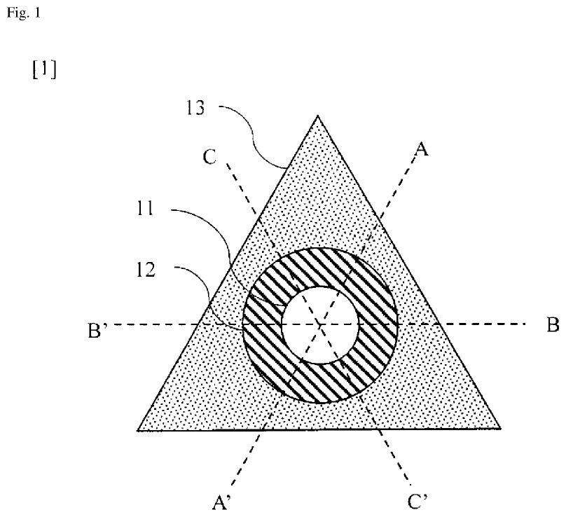

FIG. 1 to FIG. 4 illustrate the structure of the optical fiber cable having an equilateral triangular cross-sectional shape perpendicular to a long axis direction and an example of laying the optical fiber cable. In FIG. 1 to FIG. 4, reference numeral 11 denotes a coated optical fiber, reference numeral 12 denotes a tensile fiber layer, and reference numeral 13 denotes a cable jacket. The optical fiber cable illustrated in FIG. 1 includes the tensile fiber layer 12 formed around at least one coated optical fiber 11 and the cable jacket 13 collectively covering them.

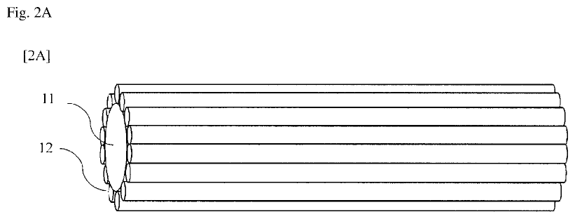

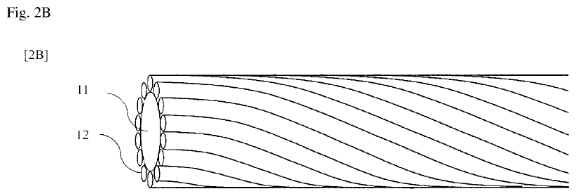

FIG. 2A and FIG. 2B illustrate a structure in which tensile fibers are longitudinally attached and spirally wound. In the optical fiber cable of FIG. 2A, tensile fibers are longitudinally attached to form a substantially concentric tensile fiber layer 12. In the optical fiber cable of FIG. 2B, tensile fibers are spirally wound to form a substantially concentric tensile fiber layer 12.

Examples of the material of the tensile fiber may include aramid and the like. Examples of the material of the cable jacket may include polyethylene, flame-retardant polyethylene, polyvinyl chloride, and the like. These materials and the method for forming the tensile fiber layer are the same in the following embodiments.

In the optical fiber cable having the cross-sectional structure illustrated in FIG. 1, when three planes A-A′, B-B′, and C-C′ are assumed to be neutral planes, the optical fiber cable has three axes each having a minimum moment of inertia of area with respect to the neutral planes.

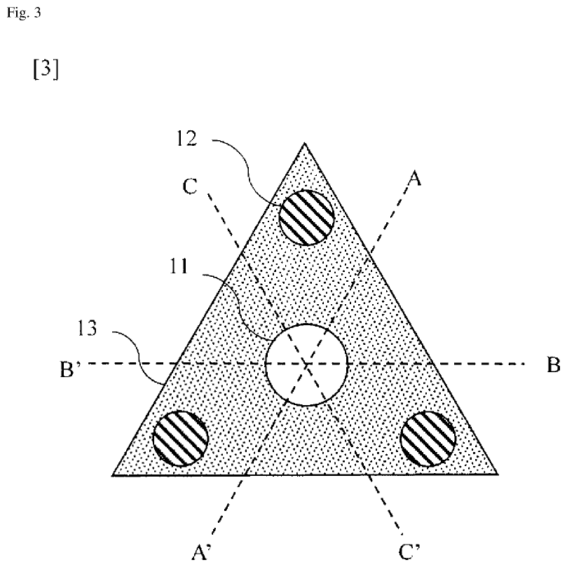

The optical fiber cable according to the present embodiment may have a structure in which the tensile fiber layer 12 is covered by the cable jacket 13 within the definition in which the optical fiber has two or more axes each having a minimum moment of inertia of area with respect to neutral planes. An optical fiber cable according to the present embodiment as illustrated in FIG. 3 has a structure in which the tensile fiber layer 12 is arranged in a distributed manner in three directions and is covered by the cable jacket 13.

In the optical fiber cable having the cross-sectional structure illustrated in FIG. 3, when three planes A-A′, B-B′, and C-C′ are assumed to be neutral planes, the optical fiber cable has three axes each having a minimum moment of inertia of area with respect to the neutral planes.

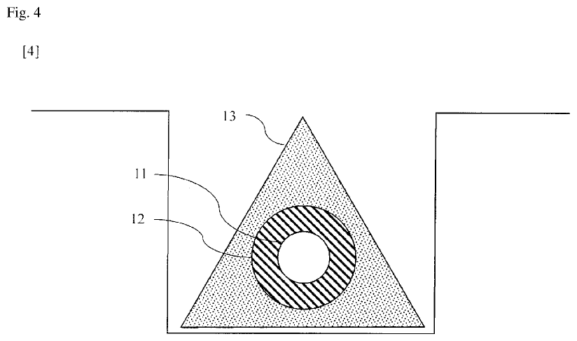

FIG. 4 illustrates an example of laying the optical fiber cable having an equilateral triangular cross-sectional shape perpendicular to the long axis direction illustrated in FIG. 1. As can be seen from FIG. 4, as compared to an optical fiber cable having a circular cross-sectional shape perpendicular to the long axis direction, since the optical fiber cable having an equilateral triangular cross-sectional shape perpendicular to the long axis direction illustrated in FIG. 1 has a large contact area with the bottom surface of a rectangular groove, the friction between the bottom surface of the rectangular groove and the optical fiber cable is large. Furthermore, the optical fiber cable can be bent and laid in at least two directions. By simply twisting the optical fiber cable illustrated in FIG. 4 by 30°, it can be bent and laid in two directions, for example, a horizontal direction and a vertical direction.

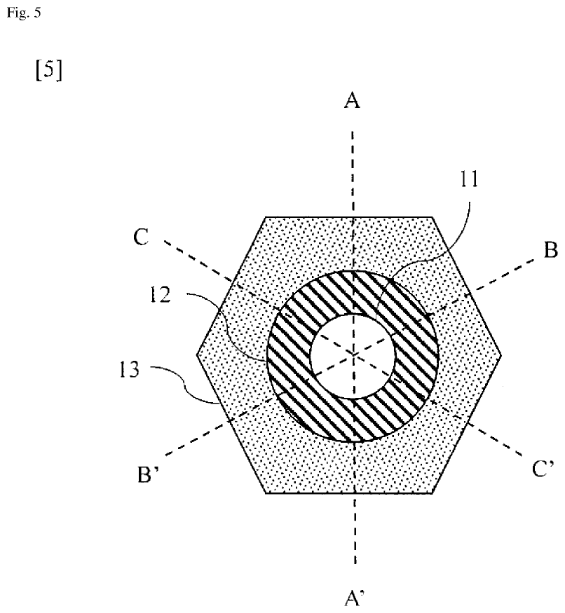

The shape of the cross-section perpendicular to the long axis direction of an optical fiber cable may be a regular hexagon. FIG. 5 illustrate the structure of an optical fiber cable having a regular hexagonal cross-sectional shape perpendicular to a long axis direction. In FIG. 5, reference numeral 11 denotes a coated optical fiber, reference numeral 12 denotes a tensile fiber layer, and reference numeral 13 denotes a cable jacket. The optical fiber cable illustrated in FIG. 5 includes the tensile fiber layer 12 formed around at least one coated optical fiber 11 and the cable jacket 13 collectively covering them.

In the optical fiber cable having the cross-sectional structure illustrated in FIG. 5, when three planes A-A′, B-B′, and C-C′ are assumed to be neutral planes, the optical fiber cable has three axes each having a minimum moment of inertia of area with respect to the neutral planes.

Furthermore, as compared to an optical fiber cable having a circular cross-sectional shape perpendicular to the long axis direction, since the optical fiber cable having a regular hexagonal cross-sectional shape perpendicular to the long axis direction illustrated in FIG. 5 has a large contact area with the bottom surface of a rectangular groove, the friction between the bottom surface of the rectangular groove and the optical fiber cable is large. Furthermore, the optical fiber cable can be bent and laid in at least two directions.

### Second Embodiment

An optical fiber cable of the present embodiment has a structure having four flat side surfaces in a long axis direction and two axes each having a minimum moment of inertia of area with respect to neutral planes. The smaller the moment of inertia of area is, the easier it is to bend, and having the two axes enables the optical fiber cable to be bent in two directions with a minimum force. Examples of the optical fiber cable include an optical fiber cable having a square cross-sectional shape perpendicular to the long axis direction.

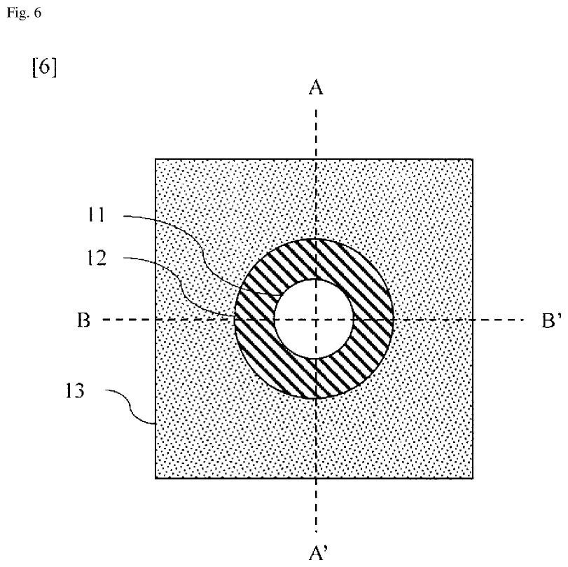

FIG. 6 to FIG. 8 illustrate the structure of the optical fiber cable having a square cross-sectional shape perpendicular to the long axis direction and an example of laying the optical fiber cable. In FIG. 6 to FIG. 8, reference numeral 11 denotes a coated optical fiber, reference numeral 12 denotes a tensile fiber layer, and reference numeral 13 denotes a cable jacket. The optical fiber cable illustrated in FIG. 6 includes the tensile fiber layer 12 formed around at least one coated optical fiber 11 and the cable jacket 13 collectively covering them.

In the optical fiber cable having the cross-sectional structure illustrated in FIG. 6, when two planes A-A′ and B-B′ are assumed to be neutral planes, the optical fiber has two axes each having a minimum moment of inertia of area with respect to the neutral planes.

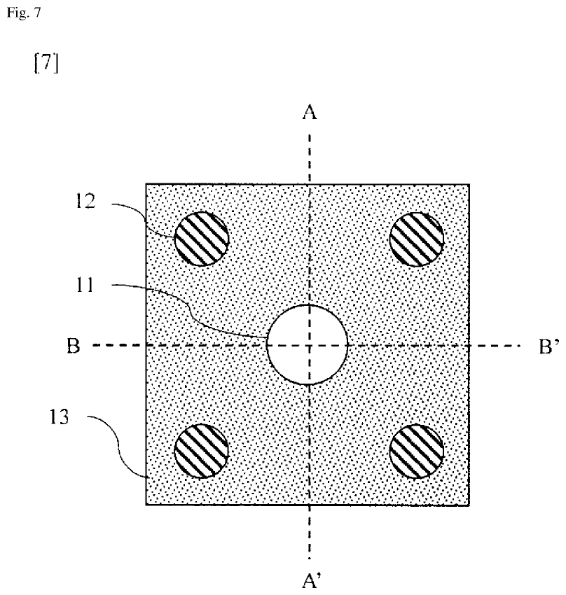

The optical fiber cable according to the present embodiment may have a structure in which the tensile fiber layer 12 is covered by the cable jacket 13 within the definition in which the optical fiber cable has two axes each having a minimum moment of inertia of area with respect to neutral planes. The optical fiber cable according to the present embodiment as illustrated in FIG. 7 has a structure in which the tensile fiber layer 12 is arranged in a distributed manner in four directions and is covered by the cable jacket 13.

In the optical fiber cable having the cross-sectional structure illustrated in FIG. 7, when two planes A-A′ and B-B′ are assumed to be neutral planes, the optical fiber cable has two axes each having a minimum moment of inertia of area with respect to the neutral planes.

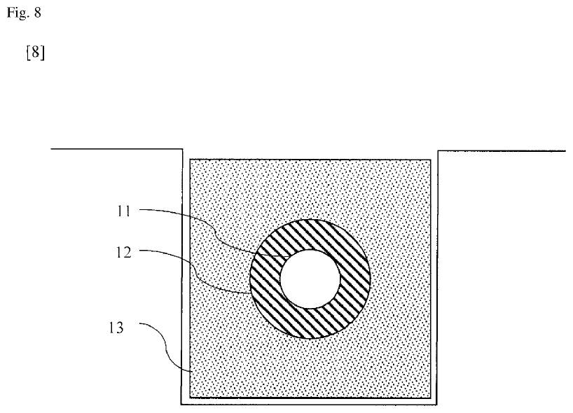

When a groove in which an optical fiber cable is to be laid is rectangular, it is desirable that the shape of the cross-section perpendicular to the long axis direction of the optical fiber cable is square in order to maximize the friction between the optical fiber cable and the bottom surface of the groove. FIG. 8 illustrates an example of laying the optical fiber cable having a square cross-sectional shape perpendicular to the long axis direction illustrated in FIG. 6. As can be seen from FIG. 8, as compared to an optical fiber cable having a circular cross-sectional shape perpendicular to the long axis direction, since the optical fiber cable having a square cross-sectional shape perpendicular to the long axis direction illustrated in FIG. 8 has a large contact area with the bottom surface of a rectangular groove, the friction between the bottom surface of the rectangular groove and the optical fiber cable is large. Furthermore, the optical fiber cable having the shape does not depend on a laying direction, and regardless of the direction in which the optical fiber cable is laid, the optical fiber cable can be bent and laid in two directions, for example, a horizontal direction and a vertical direction.

### Third Embodiment

An optical fiber cable of the present embodiment has a structure having four or more flat side surfaces in a long axis direction and two or more axes each having a minimum moment of inertia of area with respect to neutral planes. The smaller the moment of inertia of area is, the easier it is to bend, and having the two or more axes enables the optical fiber cable to be bent in two or more directions with a minimum force.

Moreover, in the optical fiber cable of the present embodiment, there are two or more sets of parallel side surfaces, facing each other, of the four or more flat side surfaces, one set of parallel side surfaces and another set of parallel side surfaces of the two or more sets of parallel side surfaces are positioned at right angles to each other, edges of side surfaces positioned at right angles to each other of the two or more sets of parallel side surfaces are not in contact with each other, and a side surface connecting the side surfaces positioned at right angles to each other is inside the extension surfaces of the side surfaces positioned at right angles to each other.

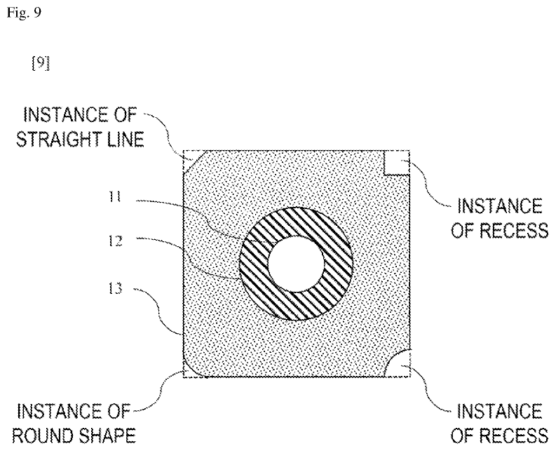

FIG. 9 to FIG. 13 illustrate the structure of the cross-section perpendicular to the long axis direction of the optical fiber cable of the present embodiment and an example of laying the optical fiber cable. In FIG. 9 to FIG. 13, reference numeral 11 denotes a coated optical fiber, reference numeral 12 denotes a tensile fiber layer, and reference numeral 13 denotes a cable jacket. The optical fiber cable illustrated in FIG. 9 includes the tensile fiber layer 12 formed around at least one coated optical fiber 11 and the cable jacket 13 collectively covering them.

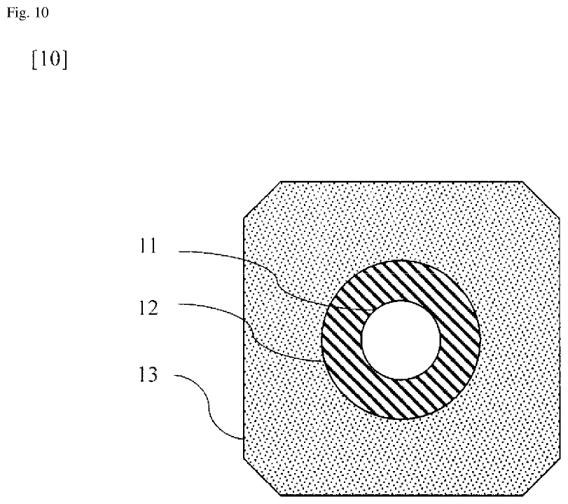

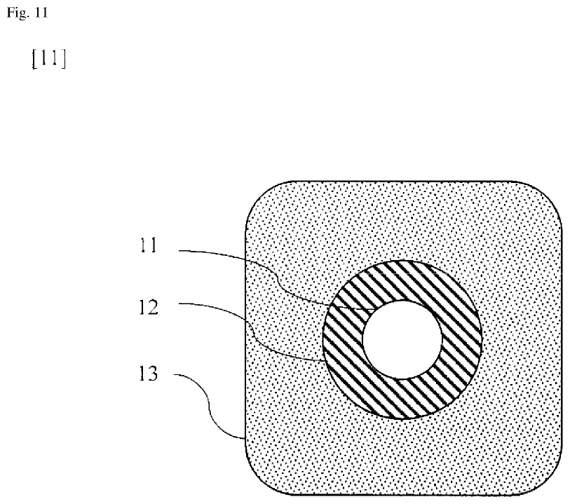

The shapes of four corners in the cross section perpendicular to the long axis direction of the optical fiber cable can be exemplified by straight lines, round shapes, recesses, and the like. Each of the four corners may have any shape as long as it is inside (on the optical fiber cable side) the extension surfaces of side surfaces, connected to it, positioned at right angles to each other. The shapes of the four corners may all be the same or different from each other at four locations. When the shapes of the four corners are all straight lines, the shape of the cross-section perpendicular to the long axis direction of the optical fiber cable is an octagon that satisfies the conditions described above. FIG. 10 illustrates the cross-sectional structure of an optical fiber cable having an octagonal cross-sectional shape perpendicular to the long axis direction. When the shapes of the four corners are all round, the shape of the cross-section perpendicular to the long axis direction of the optical fiber cable is a square with rounded corners. FIG. 11 illustrates the cross-sectional structure of an optical fiber cable in which the shape of the cross-section perpendicular to the long axis direction is a square with rounded corners.

In the optical fiber cable having the cross-sectional structure illustrated in FIG. 9, FIG. 10, and FIG. 11, when two planes are assumed to be neutral planes, the optical fiber cable has two axes each having a minimum moment of inertia of area with respect to the neutral planes.

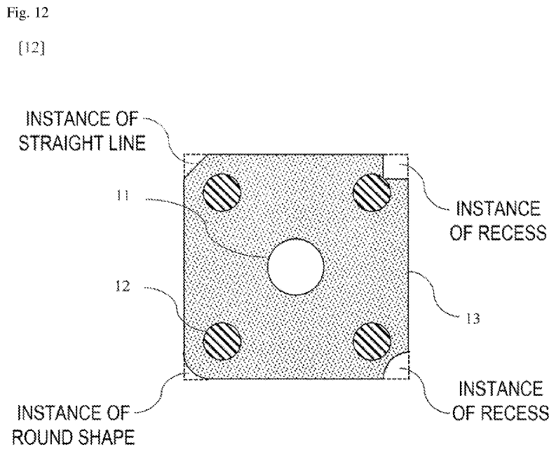

The optical fiber cable according to the present embodiment may have a structure in which the tensile fiber layer 12 is covered by the cable jacket 13 within the definition in which the optical fiber cable has two axes each having a minimum moment of inertia of area with respect to neutral planes. The optical fiber cable according to the present embodiment as illustrated in FIG. 12 has a structure in which the tensile fiber layer 12 is arranged in a distributed manner in four directions and is covered by the cable jacket 13.

The optical fiber cable, having the cross-sectional structure illustrated in FIG. 12, has two axes each having a minimum moment of inertia of area with respect to neutral planes.

Due to foreign matter such as dust in the corner of a rectangular groove in which an optical cable is to be laid, when the shape of a cross-section perpendicular to a long axis direction of the optical fiber cable is square, the bottom portion of the groove and the side surface of the optical fiber cable do not come into contact with each other, resulting in a reduction in the friction force. Therefore, as for the shape of a cross-section perpendicular to a long axis direction of an optical fiber cable to be laid in the above situation, it is desirable that each of the four corners, which connects side surfaces positioned at right angles to each other, is inside (on the optical fiber cable side) the extension surfaces of the side surfaces.

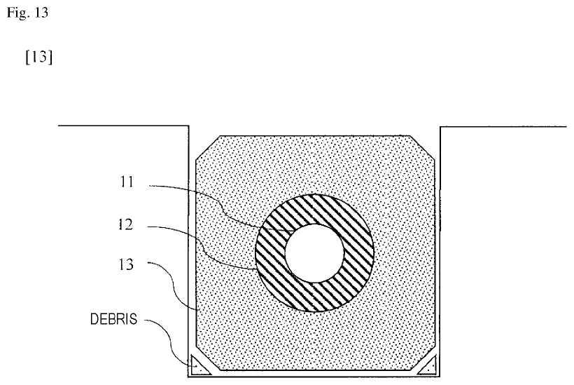

FIG. 13 illustrates an example of laying an optical cable having an octagonal cross-sectional shape perpendicular to the long axis direction of the optical fiber cable. As can be seen from FIG. 13, as compared to an optical fiber cable having a circular cross-sectional shape perpendicular to the long axis direction, since the optical fiber cable illustrated in FIG. 13 has a large contact area with the bottom surface of a rectangular groove, the friction between the bottom surface of the rectangular groove and the optical fiber cable is large. The optical fiber cable having the shape does not depend on a laying direction, and regardless of the direction in which the optical fiber cable is laid, the optical fiber cable can be bent and laid in two directions, for example, a horizontal direction and a vertical direction.

In order to give the frictional force with the rectangular groove, it is desirable that a contact area with the flat side surface of the optical fiber cable is large. Particularly, it is desirable that the sum of areas of one set of side surfaces and another set of side surfaces, which are positioned at right angles to each other, of two or more sets of parallel side surfaces is at least half the area of an outer circumference of the optical fiber cable. The friction between the bottom surface of the rectangular groove and the optical fiber cable can be increased.

### INDUSTRIAL APPLICABILITY

The present disclosure can be applied to information and communication industries.

### REFERENCE SIGNS LIST

11 Coated optical fiber
12 Tensile fiber layer
13 Cable jacket

1. An optical fiber cable, comprising:
three or more flat side surfaces in a long axis direction; and
two or more axes each having a minimum moment of inertia of area with respect to neutral planes.

2. The optical fiber cable according to claim 1, wherein
a shape of a cross-section perpendicular to the long axis direction is a square.

3. The optical fiber cable according to claim 1, wherein
a shape of a cross-section perpendicular to the long axis direction is an equilateral triangle.

4. The optical fiber cable according to claim 1, wherein
the optical fiber cable includes four or more flat side surfaces in the long axis direction,
there are two or more sets of parallel side surfaces, facing each other, of the four or more flat side surfaces,
one set of parallel side surfaces and another set of parallel side surfaces of the two or more sets of parallel side surfaces are positioned at right angles to each other,
edges of side surfaces positioned at right angles to each other of the two or more sets of parallel side surfaces are not in contact with each other, and
a side surface connecting the side surfaces positioned at right angles to each other is inside extension surfaces of the side surfaces positioned at right angles to each other.

5. The optical fiber cable according to claim 4, wherein
a sum of areas of one set of side surfaces and another set of side surfaces, which are positioned at right angles to each other, of the two or more sets of parallel side surfaces is at least half an area of an outer circumference of the optical fiber cable.

6. The optical fiber cable according to claim 4, wherein
a shape of a cross-section perpendicular to the long axis direction is a square with rounded corners.

7. The optical fiber cable according to claim 4, wherein
a shape of a cross-section perpendicular to the long axis direction is an octagon.
